(19) United States
(12) Patent Application Publication
(10) Pub. No.: US 2024/0146423 A1
(43) Pub. Date: May 2, 2024

(54) SYSTEMS AND METHODS FOR REAL-TIME CALIBRATION OF RADIO DELAYS

(71) Applicant: CACI, INC.- FEDERAL, Reston, VA (US)

(72) Inventors: Colin M. BURGIN, Chantilly, VA (US); Brandon CUNJE, Centreville, VA (US); Jeremy Dean WARRINER, Longmont, CO (US)

(21) Appl. No.: 18/487,158

(22) Filed: Oct. 16, 2023

Related U.S. Application Data
(60) Provisional application No. 63/420,866, filed on Oct. 31, 2022.

(51) Int. Cl. H04B 17/11; H04B 17/10; H04W 56/00

(52) U.S. Cl. CPC H04B 17/11; H04B 17/104; H04W 56/0045

(57) ABSTRACT

The present application at least describes a method for waveform synthesis. The method may include a step of transmitting a stimulus signal to a software defined radio (SDR) operating in a first state. The method may also include a step of receiving, via the SDR, an output signal based upon the transmitted stimulus signal. The method may also include a step of. determining, based upon the received output signal, a delay state of the SDR from a plurality of predetermined delay states of the SDR. The delay state may be associated with a parameter of the SDR. The parameter may include any one or more of a receive frequency, transmit frequency or bandwidth. The method may further include a step of generating a calibrated signal based upon the determined delay state. The method may even further include a step of sending the calibrated signal to the SDR to adjust a time.

### CROSS-REFERENCE TO RELATED APPLICATIONS

This application claims priority to U.S. Provisional Application No. 63/420,866, filed Oct. 31, 2022, entitled “Methods and Systems for Controlling Timing Capability,” the content of which is incorporated by reference herein in its entirety.

### FIELD

This application generally relates to systems and methods for calibrating delays exhibited by radios in real-time. More specifically, the systems and methods described herein are employed to calibrate radios operating in Positioning, Navigation, and Timing (PNT) systems.

### BACKGROUND

A satellite in orbit typically must maintain accurate information about its state in orbit to functional properly. Systems that provide or use this type of information may be referred to as PNT systems. Positioning refers to the satellite's ability to determine location in three dimensions relative to a selected frame of reference, e.g., an Earth-Centered, Earth-Fixed (ECEF) coordinate system. Navigation refers to the satellite's ability to employ positioning information to determine relationships between the position of multiple satellites, or alternatively, between a single satellite's position at various times. Timing refers to the satellite's ability to determine time relative to a selected time reference. For example, this may be a clock offset between the satellite's local clock and Coordinated Universal Time (UTC). Timing may also the capability to transfer local knowledge of time from one location or system to another (e.g., time transfer).

PNT systems require a high degree of synchronization accuracy. Conventional PNT systems and particularly those deployed in low earth orbit (LEO) applications, utilize low size weight, power and cost (SWaP-C) component off the shelf (COTS) devices. These low SWaP-C COTS devices do not exhibit the same radiation tolerance and precision of PNT systems used in higher elevation orbits. As a result, these devices experience one or more delay states. These delays are unacceptable in applications requiring tight time of arrival (ToA) or time of Transmission (ToT).

What is desired in the art are architectures and techniques configured to calibrate radios with tightly controlled radio frequency (RF) characteristics.

What is also desired in the art are systems including radios with calibrated delay states in near real-time configured to communicate with one or more remote systems, devices or users.

### SUMMARY

The foregoing needs are met, to a great extent, by the disclosed systems, methods, and techniques described herein.

One aspect of the present application is directed to a method of generating a calibrated signal. One step of the method includes transmitting a stimulus signal to a software defined radio (SDR) operating in a first state. Another step of the method includes receiving, via the SDR, an output signal based upon the transmitted stimulus signal. Another step of the method includes determining, based upon the received output signal, a delay state of the SDR from a plurality of predetermined delay states of the SDR. The delay state is associated with a parameter of the SDR. The parameter includes any one or more of a receive frequency, transmit frequency or bandwidth. A further step of the method includes generating a calibrated signal based upon the determined delay state. Yet even a further step of the method includes sending, to the SDR, the calibrated signal to operate in a second state with an adjusted time.

Another aspect of the present application describes a system. The system includes a non-transitory memory including store instructions and processor operably coupled thereto configured to execute a set of instructions. One of the executed instructions causes a transmission of a stimulus signal to a SDR operating in a first state. Another one of the executed instructions causes a reception of an output signal from the SDR based upon the transmitted stimulus signal. Yet another one of the instructions causes a determination of a delay state of the SDR from a plurality of predetermined delay states of the SDR based upon the received output. The delay state is associated with a parameter of the SDR. Further one of the instructions causes generation of a calibrated signal based upon the determined delay state.

Yet even another aspect of the present application describes a system including a SDR. The SDR may be configured to execute a set of instructions. One of the instructions may include sending, while in a first state, an output signal to a remote system. The output signal may indicate a delay state associated with a parameter of the SDR. Another one of the instructions may include receiving a calibrated signal from the remote system. A further one of the instructions may include updating to a second state from first state based upon the calibrated signal.

There has thus been outlined, rather broadly, certain embodiments of the application in order that the detailed description thereof herein may be better understood, and in order that the present contribution to the art may be better appreciated. There are, of course, additional embodiments of the application that will be described below and which will form the subject matter of the claims appended hereto.

### BRIEF DESCRIPTION OF THE DRAWINGS

To facilitate a fuller understanding of the application, reference is made to the accompanying drawings, in which like elements are referenced with like numerals. These drawings should not be construed to limit the application and are intended only for illustrative purposes.

FIGS. 1A and 1B illustrate block diagrams of example systems according to an aspect of the application.

FIG. 2 illustrates an example equipment device according to an aspect of the application.

FIG. 3 illustrates a block diagram of an example computing system according to an aspect of the application.

FIG. 4A illustrates an example local system communicating with a remote system according to an aspect of the application.

FIG. 4B illustrates another example local system according to an aspect of the application.

FIG. 4C illustrates another example local system according to an aspect of the application.

FIG. 5 illustrates an example reprogrammable software defined radio (SDR) schematic according to an aspect of the application.

FIG. 6A illustrates an example architecture employed to test a local system according to an aspect of the application.

FIG. 6B illustrates results associated with the example architecture employed in FIG. 6A.

FIG. 7 illustrates an example software architecture according to an aspect of the application.

FIG. 8 illustrates another example software architecture according to an aspect of the application.

FIG. 9 illustrates an example method according to an aspect of the application.

FIG. 10 illustrates another example method according to an aspect of the application.

### DETAILED DESCRIPTION

Before explaining at least one embodiment of the application in detail, it is to be understood that the application is not limited in its application to the details of construction and to the arrangements of the components set forth in the following description or illustrated in the drawings. The application is capable of embodiments in addition to those described and of being practiced and conducted in various ways. Also, it is to be understood that the phraseology and terminology employed herein, as well as the abstract, are for the purpose of description and should not be regarded as limiting.

Reference in this application to “an aspect,” “one embodiment,” “an embodiment,” “one or more embodiments,” or the like means that a particular feature, structure, or characteristic described in connection with the embodiment is included in at least one embodiment of the disclosure. The appearances of, for example, the phrases “an embodiment” in various places in the specification are not necessarily all referring to the same embodiment, nor are separate or alternative embodiments mutually exclusive of other embodiments. Moreover, various features are described which may be exhibited by some embodiments and not by the other. Similarly, various requirements are described which may be requirements for some embodiments but not for other embodiments.

In accordance with one or more aspects, the present application describes a novel approach to waveform synthesis. In an example embodiment, waveform synthesis is employed in the field of PNT systems. More specifically, the PNT systems may include low earth orbit (LEO), medium earth orbit (MEO) and high earth orbit (HEO) satellites.

According to an embodiment, the PNT system may include a precision timing and calibration (PTC) module operably in communication with a COTs SDR. The PTC module provides high reliability clock measurements in a sub-nanosecond digital time reference, power state recovery, radiation tolerance, internal closed loop RF calibration, and picosecond (ps) level time synchronization to system time. Compared to conventional systems employed in LEO, it is envisaged the system including a PTC module on-board resists single event, error/upset (SEE/SEU) radiation effects.

In an example implementation, the PTC module can calibrate an RF transmit portion of a global positioning system (GPS) or global navigation satellite system (GNSS) system. Calibrating the signal ensures transmission at a precise time. In another example implementation, the PTC module may be employed by users of handset devices anywhere in the world where GPS or GNSS is available. In an alternative implementation, a PTC module may be employed by users of walkie talkies to calibrate the RF signal.

According to an embodiment, the envisaged system including a PTC module is configured to maintain and recall state vector information in the event of system reinitialization. The system is also configured to measure environmental effects and determine its impact to RF timing. Further, the system is configured to calibrate as needed to preserve timing performance. As a result, the system may achieve timing performance comparable to national laboratory timing equipment.

In an embodiment, waveform synthesis techniques may help improve timing characteristics of RF signal generation and transmission to a remote system. In an example, the remote system may include a reprogrammable SDR. In an example, characteristics of the generated RF signals may be controlled with respect to an absolute transmit time and a phase. The absolute transmit time may be dynamically controlled at a complex baseband sample level. This approach may adjust a time of the SDR with enhanced accuracy. In an embodiment, the timing accuracy may be on the level of sub-nanoseconds, e.g., picoseconds.

In addition, the example architecture and technique support time-aligned communication protocols where a priori knowledge of UTC is required for generation and/or acquisition. As will be shown in the application, the described approaches and techniques are desirable in the context of satellite-related applications employing SDRs.

In some aspects, timing adjustments may be performed via techniques at the real-time logic (RTL) level or the software level of a remote system. In an example use case, the remote system may include but are not limited to orbiting satellites or ground stations.

### System Architecture

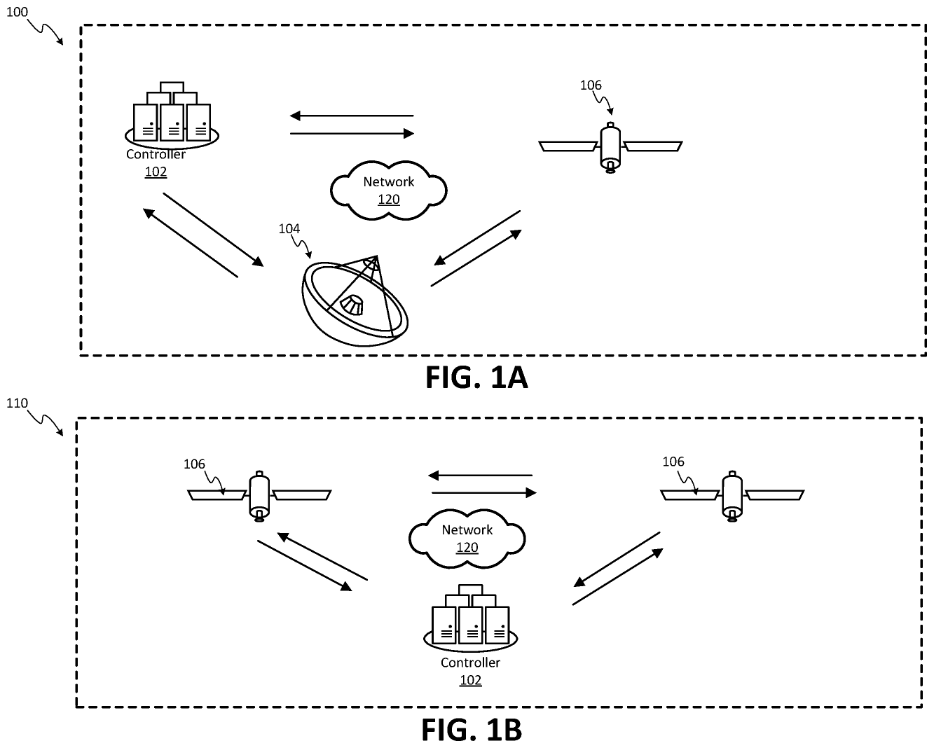

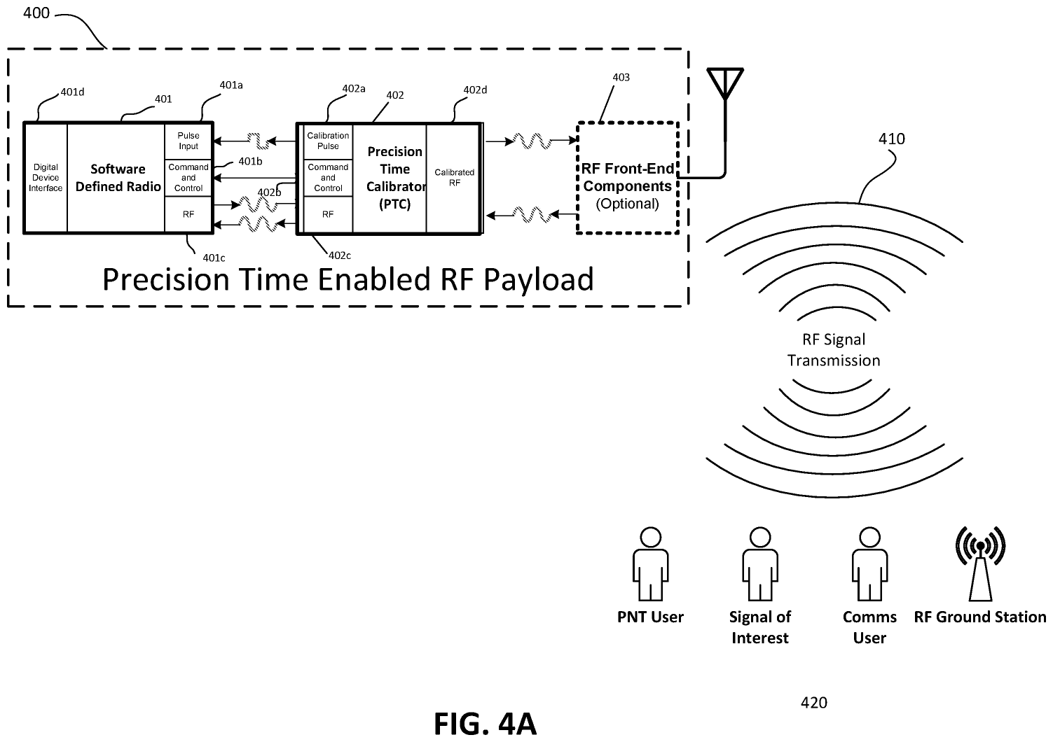

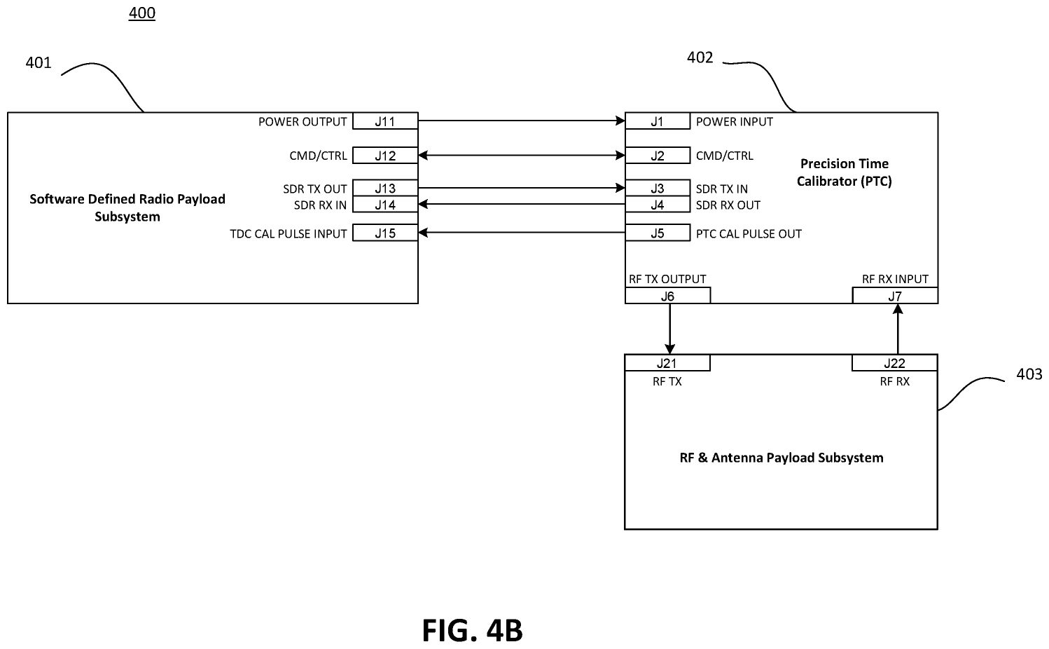

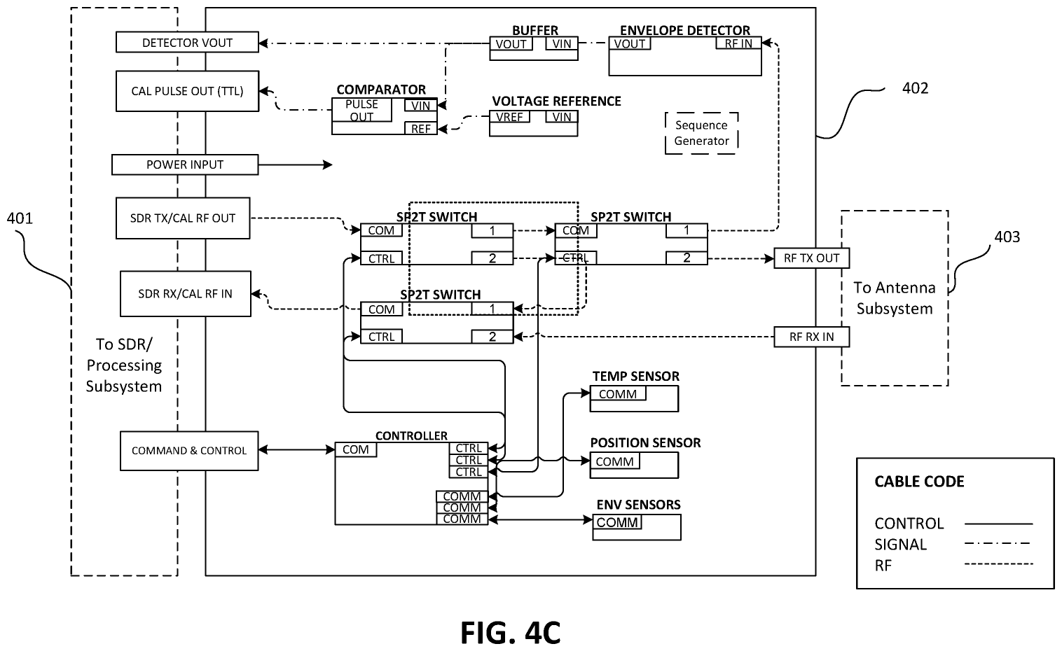

According to an exemplary embodiment, FIGS. 1A and 1B illustrate systems 100, 110, respectively, in which one or more disclosed embodiments may be implemented. The system 100 in FIG. 1A may include a controller 102 (e.g., processor) communicatively connected via a network 120 to one or more nodes. As will be described with respect to FIGS. 4A, 4B and 4C, controller 102 may be operably coupled to one or more of a PTC module and SDR on a satellite payload. As depicted in FIG. 1A, one of the nodes may include a ground station 104. In an embodiment, ground station 104 may also be a PNT or communications user or signal of interest. Another one of the nodes may include a satellite 106. The satellite may be a LEO, MEO or HEO satellite. While not shown, system 100 may include additional nodes, such as for example, another ground station, satellite, PNT or communications user or signal of interest.

The controller 102, generally speaking, may coordinate the activities and data exchanges between one or more nodes. In an embodiment, the controller 102 may be integrated with one of the nodes in the system. In an example embodiment, the controller may be integrated within the satellite 106 to form a single unit. Alternatively, the controller 102 may be located remote from the illustrated nodes.

The system 110 in FIG. 1B operates in a similar fashion as system 100 in FIG. 1A. Similar reference indicators will be preserved among both FIG. 1A and FIG. 1B. Instead of a ground station communicating with a satellite as depicted in FIG. 1A, FIG. 1B illustrates two satellites 106 in communication with each other and with a controller 102. It is envisaged that both satellites 106 could be ground stations in an embodiment.

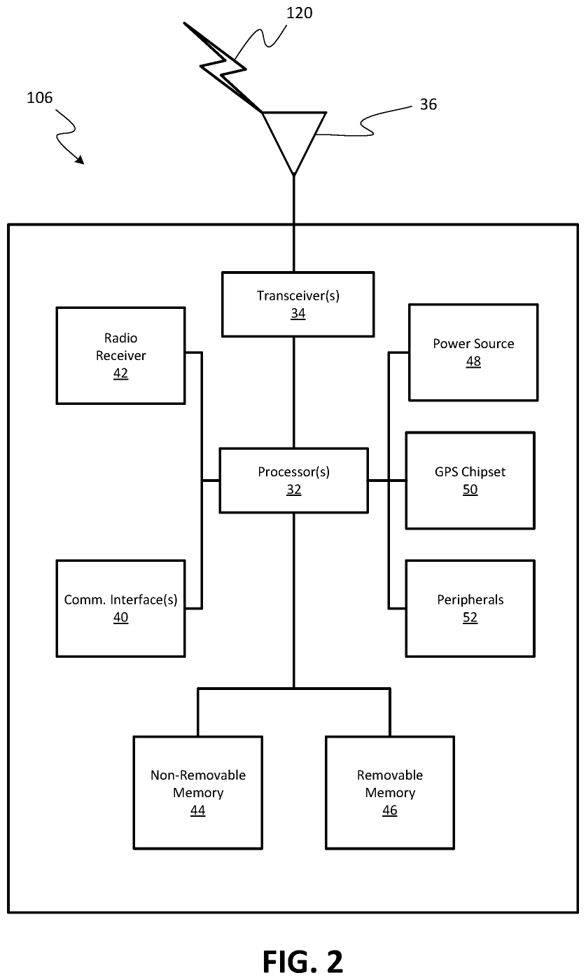

FIG. 2 is a block diagram of an exemplary hardware/software architecture of a node in a system of FIG. 1. As shown in FIG. 2, the node may be a satellite 106 or alternatively, a ground station 104. The node 106 may include one or more processors 32, a communication interface 40, a radio receiver 42, non-removable memory 44, removable memory 46, a power source 48, a GPS or GNSS chipset 50, and other peripherals 52. The node 106 may also include communication circuitry, such as one or more transceivers 34 and a transmit/receive element 36. It will be appreciated that node 106 may include any sub-combination of the foregoing elements while remaining consistent with an embodiment.

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., the non-removable memory 44 and/or the memory 46) of the node 106 in order to perform its various required functions.

The processor 32 is coupled to its communication circuitry (e.g., the transceiver 34, the transmit/receive element 36, the radio receiver 42, and the communication interface 40). The processor 32, through the execution of computer executable instructions, may control the communication circuitry in order to cause the node 106 to communicate with other components of the system. In an example, node 106 may be a satellite system which communicates with a ground station 104 and/or controller 102. The processor 32 may further control the communication circuitry to detect and capture radio spectrum and radio signal data via the transmit/receive element 36 and the radio receiver 42. The radio receiver 42 may comprise a software-defined radio (SDR) receiver. The radio receiver 42 may define one or more channels, such as one or more channels to scan a frequency spectrum for any radio signals associated with a primary user and one or more channels to capture identified radio signal data associated with a primary user.

The transmit/receive element 36 may be configured to receive (i.e., detect) a primary signal (e.g., from a ground station or another satellite) in the node's 106 RF environment. For example, in an embodiment, the transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, the transmit/receive element 36 may be configured to transmit and receive both RF and light signals.

It will be appreciated that the transmit/receive element 36 may be configured to transmit and/or receive any combination of wireless or wired signals. The transceiver 34 and/or transmit/receive element 36 may be integrated with, in whole or in part, the communication interface(s) 40, particularly wherein a communication interface 40 comprises a wireless communication interface.

The processor 32 may access information from, and store data in, any type of suitable memory, such as the non-removable memory 44 and/or the removable memory 46. For example, the processor 32 may store captured radio signal data (e.g., FA packets and digital I&Q data) in its memory, as described above. The non-removable memory 44 may include random-access memory (RAM), read-only memory (ROM), a hard disk, or any other type of memory storage device. The removable memory 46 may include a subscriber identity module (SIM) card, a memory stick, a USB drive, a secure digital (SD) memory card, and the like. In other embodiments, the processor 32 may access information from, and store data in, memory that is not physically located on the node 106. The non-removable memory 44, the removable memory 46, and/or other associated memory may comprise a non-transitory computer-readable medium configured to store instructions that, when executed, effectuate any of the various operations described herein.

The processor 32 may receive power from the power source 48 and may be configured to distribute and/or control the power to the other components in the node 106. The power source 48 may be any suitable device for powering the node 106. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The power source 48 may be additionally or alternatively configured to receive power from an external power source.

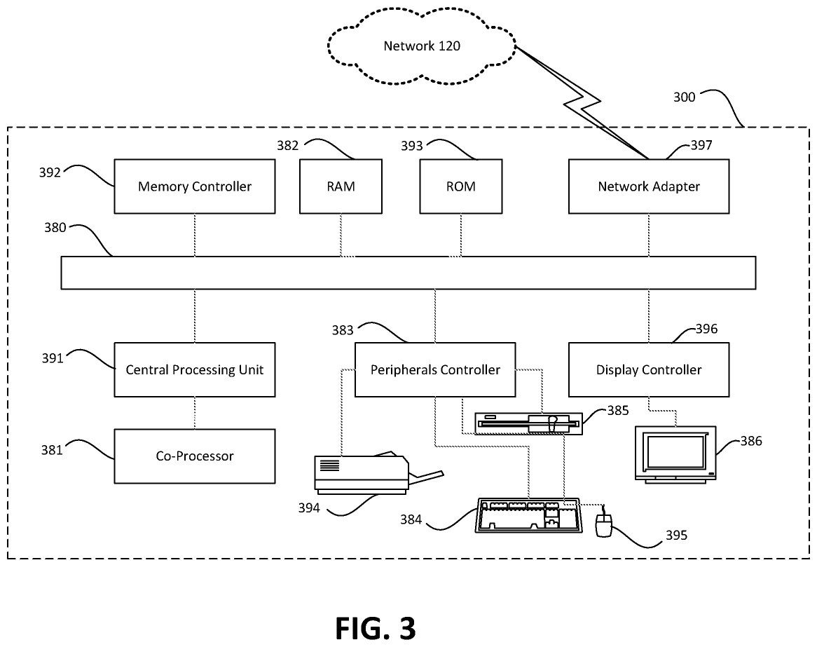

FIG. 3 depicts a block diagram of an exemplary computing system 300 which may be used coordinate with one or more components of the system, including node 106, ground station 104, and/or controller 102 depicted in FIG. 1A or 1B. In one or more embodiments, the computing system may be, or form port of, controller 102. The computing system 300 may comprise a computer or server and may be controlled primarily by computer-readable instructions (e.g., stored on a non-transitory computer-readable medium), which may be in the form of software, wherever, or by whatever means such software is stored or accessed. Such computer-readable instructions may be executed within a processor, such as a central processing unit (CPU) 391, to cause the computing system 300 to do work. In many known workstations, servers, and personal computers, the CPU 391 is implemented by a single-chip CPU called a microprocessor. In other machines, the CPU 391 may comprise multiple processors. A coprocessor 381 is an optional processor, distinct from the CPU 391 that performs additional functions or assists the CPU 391. The CPU 391 and/or the coprocessor 381 may receive anomaly detection data from a node 106 to detect a primary signal in the node's 106 RF environment.

In operation, the CPU 391 fetches, decodes, executes instructions, and transfers information to and from other resources via the computer's main data-transfer path, system bus 380. Such a system bus connects the components in the computing system 300 and defines the medium for data exchange. The system bus 380 typically includes data lines for sending data, address lines for sending addresses, and control lines for sending interrupts and for operating the system bus 380. An example of such a system bus 380 may be the PCI (Peripheral Component Interconnect) bus or PCI Express (PCIe) bus.

Memories coupled to the system bus 380 include random access memory (RAM) 382 and read only memory (ROM) 393. Such memories include circuitry that allows information to be stored and retrieved. The RAM 382, the ROM 393, or other associated memory may comprise a non-transitory computer-readable medium configured to store instructions that, when executed, effectuate any of the various operations described herein. The ROMs 393 contain stored data that cannot easily be modified. Data stored in the RAM 382 may be read or changed by the CPU 391 or other hardware devices. Access to the RAM 382 and/or the ROM 393 may be operated by a memory controller 392. The memory controller 392 may provide an address translation function that translates virtual addresses into physical addresses as instructions are executed. The memory controller 392 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, the computing system 300 may comprise a peripherals controller 383 responsible for communicating instructions from the CPU 391 to peripherals, such as a printer 394, a keyboard 384, a mouse 395, and a disk drive 385. A display 386, which is controlled by a display controller 396, is used to display visual output generated by the computing system 300. Such visual output may include text, graphics, animated graphics, and video. Visual output may further comprise a GUI. The display 386 may be implemented with a CRT-based video display, an LCD-based flat-panel display, gas plasma-based flat-panel display, or a touch-panel. The display controller 396 includes electronic components required to generate a video signal that is sent to the display 386.

Further, the computing system 300 may comprise communication circuitry, such as a network adaptor 397, that may be used to connect the computing system 300 to a communications network, such as the network 120 of FIG. 1A or 1B, to enable the computing system 300 to communicate with other components of the system and network.

### System Including PTC Module

According to an aspect of the present application, FIG. 4A depicts an example system 400 including an SDR 401 and a PTC module 402. System 400 may also include an optional RF front-end component. In an embodiment, SDR 401 may include a pulse input 401a, command-and-control module 401b, an RF 401c, and a digital device interface 401d.

In an embodiment, PTC module 402 may include a calibration pulse 402a which communicates with pulse input 401a of SDR 401. PTC module 402 may also include a command-and-control module 402b which communicates with command and control module 401b of SDR 401. PTC module 402 may further include an RF 402c which communicates bidirectionally with RF 401c of SDR 401. PTC module 402 may also include a calibrated RF 402d which bi-directionally communicates with RF front component 403.

As further depicted in FIG. 4A, system 400 may communicate via RF signal transmissions 410 to one or more entities 420. In an embodiment, these entities may include but not limited to a PNT user, signal of interest, communications user, or RF ground station.

According to another embodiment as exemplary illustrated in FIG. 4B, functionality of system 400 is described in further detail. Specifically, SDR 401 may include a power input J11 which unidirectionally transmits a signal to power input J1 of the PTC module 402. Command-and-control module J12 of SDR 401 bidirectionally communicates via signals with command-and-control module J2 of PTC module 402. Additionally, a transmission out J13 of SDR 401 unidirectionally transmits a signal to SDR transmission in J3 of PTC module 402. An SDR reception out J4 of PTC 402A unidirectionally transmits a signal to reception in J14 of SDR 401. Further, a PTC calibration pulse output J5 of PTC module 402 is unidirectionally received at a TDC calibration pulse input J15 of SDR 401. The TDC module within the SDR 401 may be configured to measure a calibration pulse to an accuracy of greater than 100 ps. It is envisaged that the system 400 may determine a state and relevant delays of the SDR 401 associated with transmitted RF Energy from SDR TX OUT J13.

PTC module 402 may also include an RF transmission output J6 and an RF reception input J7. As depicted in FIG. 4B, RF transmission output J6 of PTC module 402 bidirectionally communicates signals with RF transmission J21 of the RF and RF front-end component 403. Moreover, RF reception output J22 of the RF and RF front-end component 403 unidirectionally communicates a signal to RF reception input J7 of PTC module 402.

According to yet another embodiment of the application, FIG. 4C depicts hardware present in the PTC module 402. PTC module 402 may include an envelope detector and a comparator used to generate a calibration pulse output (TTL) that is transmitted to the SDR 401. The PTC module 402 may further include a microcontroller that commands and controls one or more peripheral devices. PTC module 402 also includes one or more RF switches used to change RF signal path. The ability to control, loop, and feedback RF allows the PTC module 402 to have complete control over RF path timing.

The PTC module 402 may include one or more onboard sensors used to detect conditions of the system 400 in real-time. For example, FIG. 4C at least depicts a temperature sensor, position sensor, and environmental sensor. In an example, the calibration table may be generated and referenced to understand one or more conditions detected by the sensors. Calibrations of RF paths and related cables of the PTC module 402, such as for example temperature, may be used to further refine precision timing accuracy.

In an example embodiment, PTC module 402 may also include a sequence generator (shown in dotted lines as an optional component). The sequence generator may be used to generate a sequence tied to a SDR PPS or UTC PPS. This signal is received by SDR 401 and used for offset calibration. Upon doing so, an RF signal may be transmitted to a third party system/user.

It is also envisaged that the PTC module 402 facilitates a technique of using a spread code or sequence generator to calibrate the RF at a modulation level. In an embodiment, it is envisaged the spread code or sequence generator may be coupled with the PTC CAL Pulse to calibrate SDR TX and RX ports with ultra-high precision.

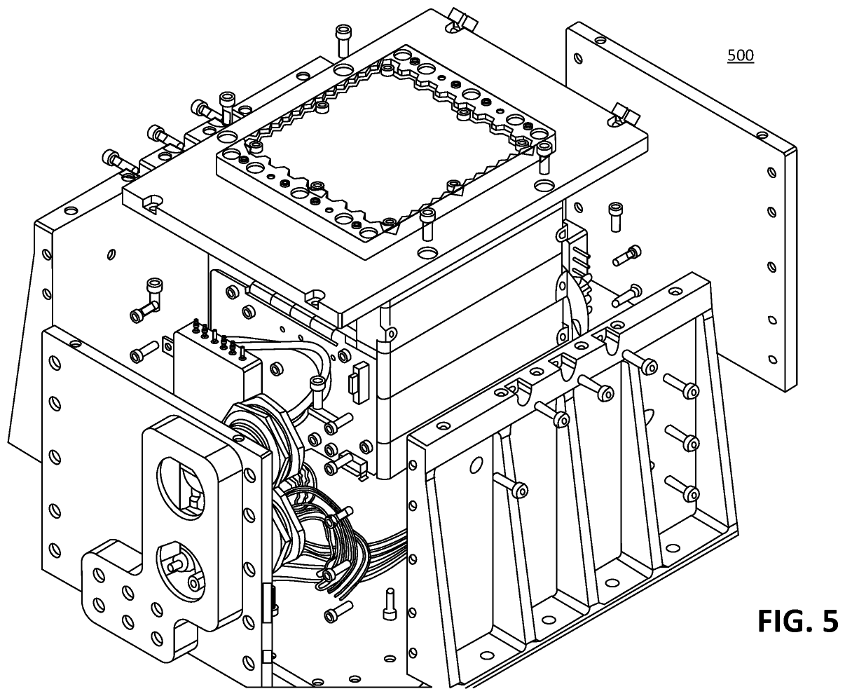

According to another aspect of the present application, FIG. 5 depicts an example reprogrammable SDR 500 used in one or more architectures and techniques of the present application. For example, SDR 500 may be employed as SDR 401 in FIGS. 4A, 4B and 4C in an embodiment. Generally, SDR 500 allows an adaptable communications platform to change a modulation of signals with software. In an exemplary use case, SDR 500 allows the adaptable communications platform to establish a link with one or more satellites. SDR 500 may allow one adaptable communications platform to switch between the BPSK, QPSK, 8PSK, QAM, CDMA, GSM, and other signal modulation waveforms that various communication devices utilize. In an embodiment, forward error correction (FER), compression, conditional access, and encryption are all achieved with software.

As shown in FIG. 5, reprogrammable SDR 500 may include an EMI filter, RF connection breakouts, power/digital connectors, power supplies, a core payload, and a Ka band APA. Specifically, SDR operates in a Ka band frequency. The Ka band includes frequencies ranging from 27 GHz to 40 GHz. The Ka band may include wavelengths ranging between 1.1 to 0.75 centimeters.

The Ka band is configured to transport high-speed data communication with wide coverage through multiple beams. The Ka band frequency allows the SDR to employ an antenna with a smaller footprint. Ka band frequency may be used in various used cases such as for example those requiring high-resolution, close-range targeting radars, military aircraft, space telescopes, commercial, wireless point-point microwave communication systems, vehicle speed detection systems, and satellite communications.

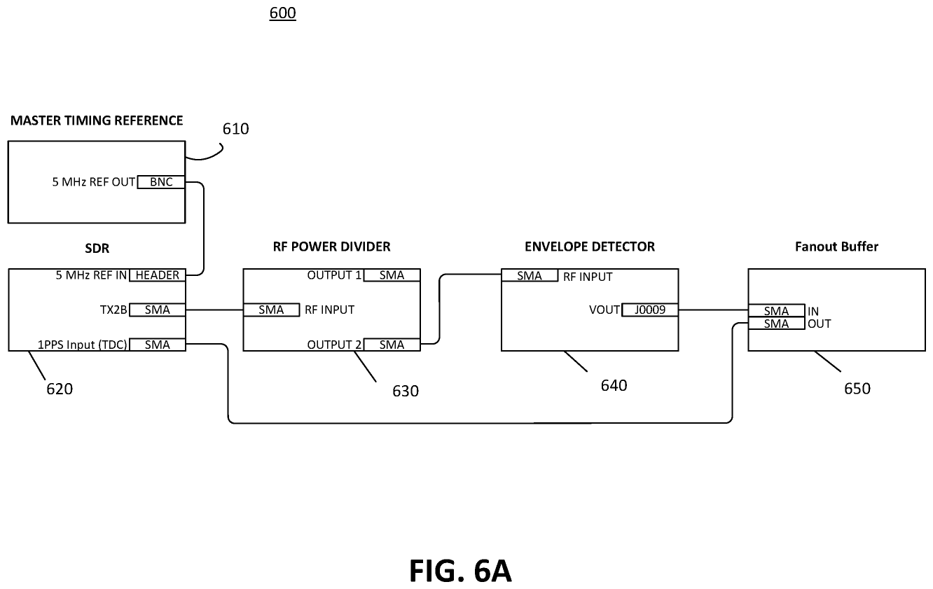

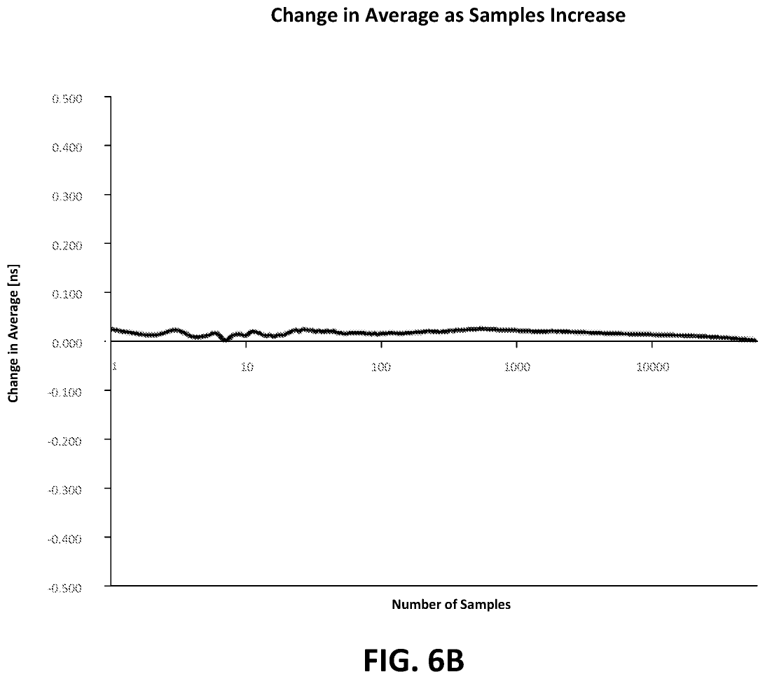

According to yet another aspect of the present application, FIG. 6A depicts a testing system 600. Testing system 600 may include a master timing reference 610, SDR 620, RF power divider 630, envelope detector 640, and a fan out 650 buffer. In particular, the timing reference 610 may include a 5 MHz reference out transmitted to the SDR 620 via its header. The SDR may receive a 1 PPS input (TDC) from the fan out buffer 650. SDR 620 may transmit an SMA to the RF power divider 630. The SMA received at the RF power divider 630 may be transmitted to the envelope detector 640. A voltage out from the envelope detector 640 is transmitted to the fan out buffer 650.

Testing in view of the system 600 depicted in FIG. 6A was employed to verify a proof-of-concept design. In particular, greater than five (5) hours of RF measurements were collected. The collected data was used to compute a measured delay against a ground truth. The results suggest that the PTC module 402 may provide relevant calibration feedback at room temperature. The results are beyond what is understood to be capable on a conventional system in the field of endeavor.

FIG. 6B depicts a graphical representation of a change in average in nanoseconds versus a number of samples. The data is based upon the testing system 600 depicted in FIG. 6A. As indicated in the graphical representation, the results show an average around zero (0). The graphical representation illustrates a change in average value as the number of collected samples are increase. The graphical representation also indicates a relatively stable measurement achieved after about 10 samples. According to the graphical representation, a 25 ps RMS error was observed after 10 samples. After 50 samples a 10 ps RMS error was observed.

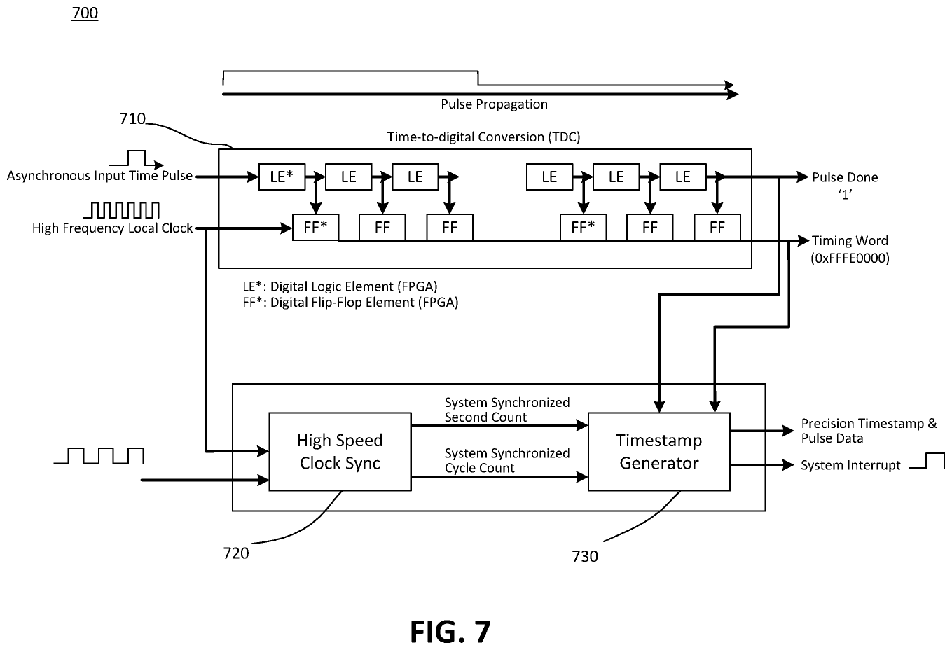

According to even another aspect of the present application, system 700 in FIG. 7 depicts a simplified version of a time-to-digital converter (TDC). In an embodiment, system 700 may be implemented in a FPGA device employed in tandem with the above-mentioned PTC module 402. The top half 710 of FIG. 7 illustrates a serial logic/storage chain that can be used to take sub-cycle measurements of an incoming asynchronous time pulse. The asynchronous pulse information is transferred to the bottom half of the diagram (720 and 730) where a synchronous high-speed timestamp is correlated and appended to the data. The precision timestamping of the input pulse may be converted to a local time better than 100 ps. It is envisaged the current software architecture may be implemented in high & low-cost FPGA platforms for development and testing.

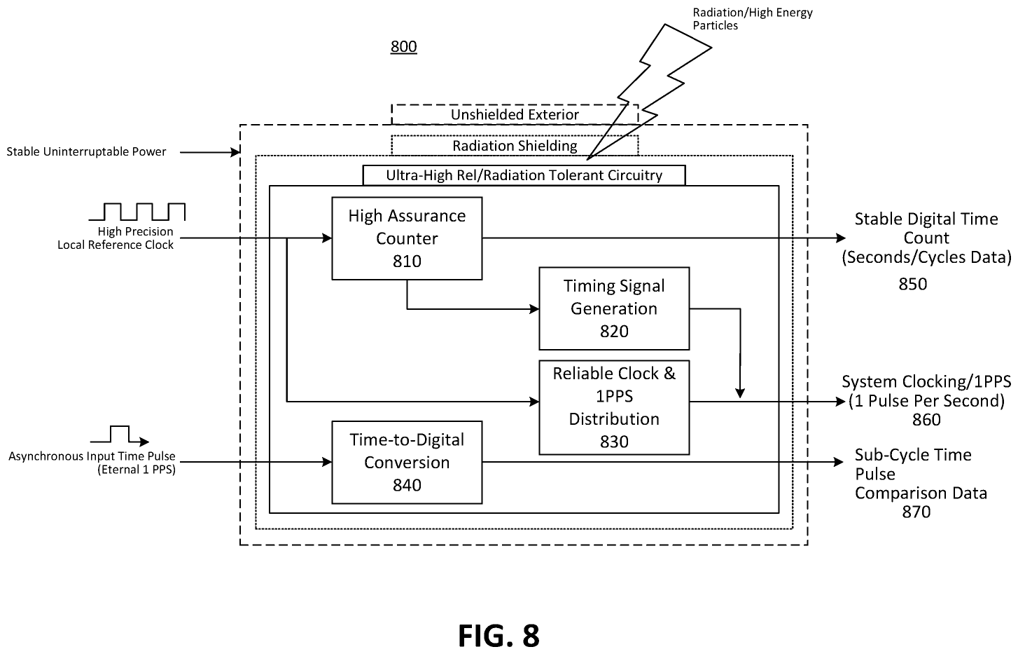

According to a further aspect of the present application, another embodiment of a PTC module 800 is depicted in FIG. 8. The PTC module 800 may include a radiation tolerant FPGA, discrete digital logic, and mixed signal circuitry. The PTC module 800 or a system containing the PTC module may include radiation shielding. It is envisaged that PTC 800 may provide precise timing measurements even in high-radiation environments. High radiation environment may include space related missions, particularly in LEO, MEO and HEO.

The PTC module 800 may continuously monitor an on-board clock source and timing reference. The PTC module 800 may also determine what a time should be. The PTC module 800 may subsequently provide the determined time, as a timing reference, to one or more connected devices.

As shown in FIG. 8, PTC module 800 may include a high assurance counter 810 that receives a high precision local reference clock pulse input. A portion of the high precision local reference clock pulse may also be transmitted to a reliable clock and 1 PPS distribution module (RCDM) 830.

The high assurance counter 810 may transmit a signal to a timing signal generator 820. Another output of the high assurance counter 810 is transmitted to a stable digital time count (seconds/cycles dates) module 850.

An output of RCDM 830 is combined with an output of the timing signal generator 820. The combined output is subsequently transmitted to a system clocking/1 PPS module 860.

PTC module 800 also receives an asynchronous input time pulse (eternal 1 PPS) at a TDC module 840. An output from the TDC module 840 is transmitted to a sub-cycle time pulse/comparison data module 870.

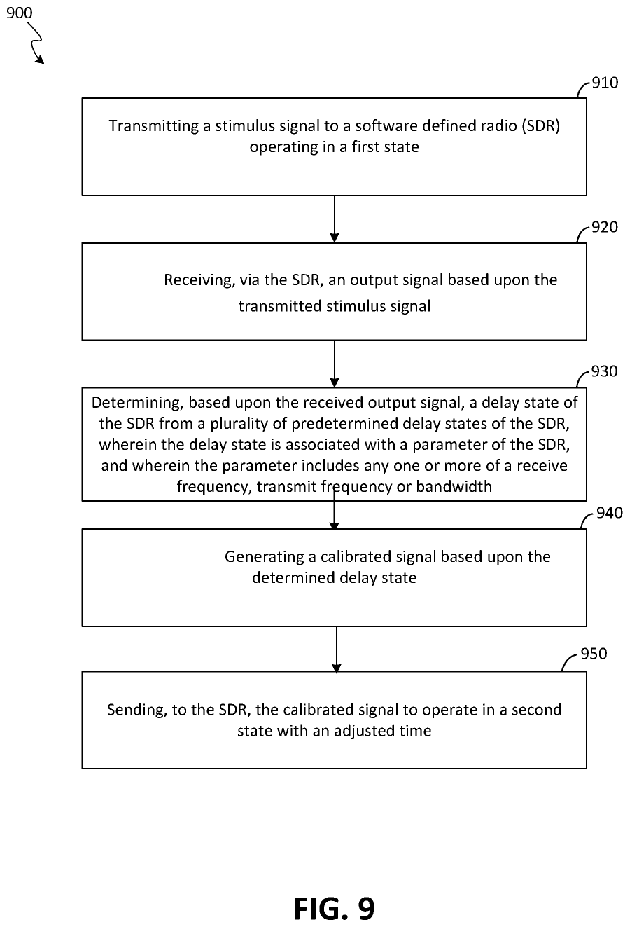

According to yet even a further aspect of the present application, an exemplary method 900 is described as depicted in FIG. 9. One of the steps of method 900 in FIG. 9 may include transmitting a stimulus signal to a software defined radio (SDR) operating in a first state (910). Another step of method 900 in FIG. 9 may include receiving, via the SDR, an output signal based upon the transmitted stimulus signal (920). Yet another step of method 900 in FIG. 9 may determining, based upon the received output signal, a delay state of the SDR from a plurality of predetermined delay states of the SDR, wherein the delay state is associated with a parameter of the SDR, and wherein the parameter includes any one or more of a receive frequency, transmit frequency or bandwidth (930). A further step of method 900 in FIG. 9 may include generating a calibrated signal based upon the determined delay state (940). Even a further step of method 900 in FIG. 9 may include sending, to the SDR, the calibrated signal to operate in a second state with an adjusted time (950).

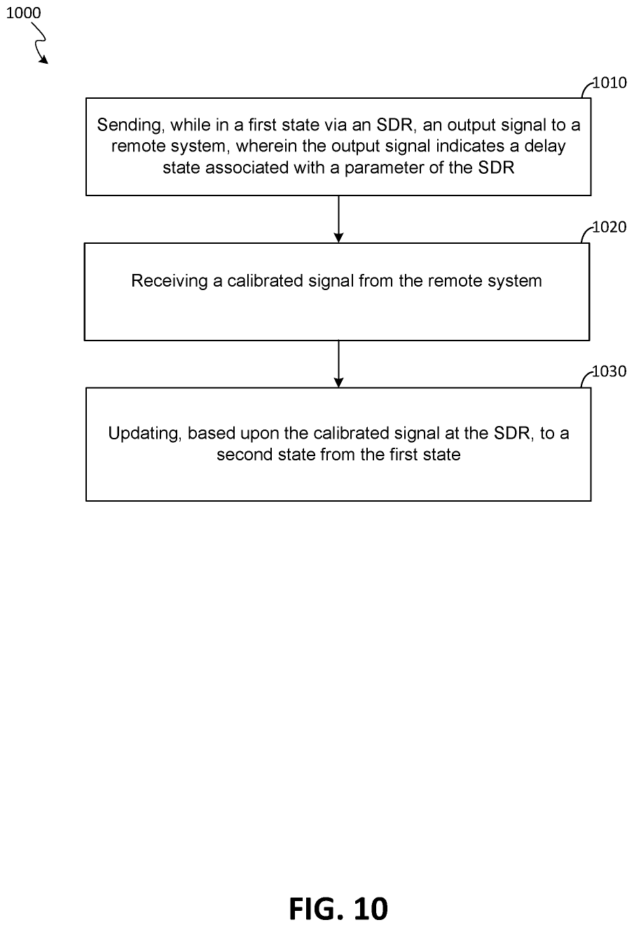

According to yet a further aspect of the present application, an exemplary method 1000 is described as depicted in FIG. 10. The method 1000 in FIG. 10 may be executed by an SDR. One of the steps (1010) in FIG. 10 may include sending, while in a first state via an SDR, an output signal to a remote system. The output signal may indicate a delay state associated with a parameter of the SDR. In an embodiment, the parameter may include any one or more of a receive frequency, transmit frequency or bandwidth. Another one of the steps (1020) in FIG. 10 may include receiving a calibrated signal from the remote system. In an embodiment, the calibrated signal is a function of an operating temperature of the SDR. A further one of the steps (1030) in FIG. 10 may include updating the SDR to a second state from first state based upon the calibrated signal.

According to an embodiment, the SDR and the remote system may be co-located in a satellite. The satellite may exhibit a temperature ranging between −20° C. and 50° C. The satellite may also exhibit an internal pressure of about 10⁻⁵ Torr.

While the systems and methods have been described in terms of what are presently considered specific embodiments, the disclosure need not be limited to the disclosed embodiments. It is intended to cover various modifications and similar arrangements included within the spirit and scope of the claims, the scope of which should be accorded the broadest interpretation to encompass all such modifications and similar structures. The present application includes any and all embodiments of the following claims.

What is claimed is:

1. A method comprising:
transmitting a stimulus signal to a software defined radio (SDR) operating in a first state;
receiving, via the SDR, an output signal based upon the transmitted stimulus signal;
determining, based upon the received output signal, a delay state of the SDR from a plurality of predetermined delay states of the SDR, wherein the delay state is associated with a parameter of the SDR, and wherein the parameter includes any one or more of a receive frequency, transmit frequency or bandwidth;
generating a calibrated signal based upon the determined delay state; and
sending, to the SDR, the calibrated signal to operate in a second state with an adjusted time.

2. The method of claim 1, further comprising:
receiving another output signal from the SDR operating in the second state; and
determining, based upon the received other output, another delay state of the SDR from among the plurality of predetermined delay states of the SDR.

3. The method of claim 2, further comprising:
generating another calibrated signal based upon the other state; and
transmitting the other calibration signal to the SDR for operating in a third state.

4. The method of claim 1, wherein the predetermined delay states are obtained by:
collecting, prior to the transmitting step, a plurality of signals output from the SDR; and
characterizing the parameter for each of the collected signals.

5. The method of claim 1, wherein the stimulus signal includes a radio frequency signal and a pulse per second (PPS) signal.

6. The method of claim 1, wherein the stimulus signal include a GNSS waveform.

7. The method of claim 1, wherein the delay state ranges between 12.5 ps/° C. and −3.5 ps/° C.

8. The method of claim 1, where the calibrated signal is a function of an operating temperature of the SDR.

9. The method of claim 1, wherein the calibrated signal is a sub-nanosecond signal measured.

10. A system comprising:
non-transitory memory including instructions stored thereon; and
a processor operably coupled to the non-transitory memory, wherein the processor is configured to execute the instructions including:
causing a transmission of a stimulus signal to a software defined radio (SDR) operating in a first state;
causing a reception of an output signal from the SDR based upon the transmitted stimulus signal;
determining, based upon the received output signal, of a delay state of the SDR from a plurality of predetermined delay states of the SDR, wherein the delay state is associated with a parameter of the SDR; and
causing to generate a calibrated signal based upon the determined delay state.

11. The system of claim 10, wherein the processor is further configured to execute the instructions of causing to send the calibrated signal to the SDR.

12. The system of claim 10, further comprising:
a signal generator and a clock/calibration module.

13. The system of claim 12, wherein the processor, the signal generator and the clock/calibration module are housed in a single casing.

14. The system of claim 10, wherein the parameter includes any one or more of a receive frequency, transmit frequency or bandwidth.

15. A system comprising a software defined radio (SDR), wherein the SDR is configured to execute a set of instructions including:
sending, while in a first state, an output signal to a remote system, wherein the output signal indicates a delay state associated with a parameter of the SDR;
receiving, from the remote system, a calibrated signal; and
updating, based upon the calibrated signal, to a second state from the first state.

16. The system of claim 15, further comprising:
the remote system,
wherein the SDR and remote system are co-located in a satellite.

17. The system of claim 16, wherein the satellite exhibits a temperature ranging between −20° C. and 50° C.

18. The system of claim 17, wherein the satellite exhibits an internal pressure of about 10⁻⁵ Torr.

19. The system of claim 15, wherein the parameter includes any one or more of a receive frequency, transmit frequency or bandwidth.

20. The system of claim 15, where the calibrated signal is a function of an operating temperature of the SDR.
